(19) United States
(12) Patent Application Publication
(10) Pub. No.: US 2007/0175478 A1
(43) Pub. Date: Aug. 2, 2007

(54) Nasal air purifier

(76) Inventor: Robert F. Brunst, Olivenhain, CA (US)

Correspondence Address: Harry V. McGahey, Esq., 1532 Sixth Ave., San Diego, CA, 92101, US

(21) Appl. No.: 11/700,432

(22) Filed: Jan. 31, 2007

Related U.S. Application Data
(60) Provisional application No. 60/764,212, filed on Feb. 1, 2006.

(51) Int. Cl. A62B 18/02; A62B 19/00; A62B 23/02

(52) U.S. Cl. 128/206.18; 128/205.29; 128/206.17

(57) ABSTRACT

An improved nasal air filtration apparatus comprised of a flat, disk shaped baffle air filter inserted into each nostril, so that upon inspiration the air filter is closed from the inspiration air pressure, and upon exhalation the air filter is opened by the exhalation air pressure, allowing easier and more efficient breathing of filtered air through the nostrils.

### CROSS-REFERENCE

This application is entitled to the benefit of the provisional patent application No. 60/764,212 filed Feb. 1, 2006 with the United States Patent Office.

### FEDERAL ASSISTANCE

No Federal money or grant was used in the development of this invention.

### BACKGROUND

Every year, millions of Americans are afflicted by respiratory infections due to viruses, bacteria or various infections. Many of these pathogens are transmitted from one person to another through the air. Ninety-Six percent of the air we need is inhaled through the nose and an effective barrier to these pathogens placed in each nostril could potentially greatly reduce the transmission of these infections. There would still be the possibility of transmission orally, but transmission into the nasal membranes could potentially be greatly reduced.

### RELATED ART

Other inventions have attempted to address this problem, however, generally other attempted solutions have suffered from one or more of the following disadvantages:

(1) They do not use High Efficiency Particulate Arrestor (HEPA) filter systems and therefore cannot offer as great a filtering capacity for influenza and other viruses;

(2) Even if they use a HEPA filter, they must be assembled by the wearer with multiple small parts;

(3) They do not have any valves and therefore tend to engage on both inspiration and exhalation, making them less comfortable to wear;

(4) The valve systems used unduly restrict the amount of air flowing in or out of the device upon inhalation and exhalation;

(5) Because the exhalation valves do not allow enough air to move in and out of the lungs on inspiration and expiration, these other systems tend to encourage the wearer to breath through his or her mouth, thereby more easily allowing microbes to be ingested orally;

(6) They require exterior shroud pre-filter assemblies;

(7) They incorporate noisy flutter valves which tend to make noise upon exhalation;

(8) They include multiple parts which because they must be factory assembled are more expensive to manufacture;

(9) They must use replaceable cartridges which are more expensive than the current invention which can simply be disposed of after use;

(10) They use uncomfortable septum clips to hold them in;

(11) They must be swiveled in for use;

(12) They use filters which do not allow enough air to move through on expiration and therefore the systems tend to cause themselves to be expelled on exhalation;

(13) They are not comprised of, nor do they have a layer of tissue friendly material surrounding them on their exterior casing; and/or

(14) They are not completely disposable.

### BRIEF SUMMARY OF THE INVENTION

In this invention, the filter element itself constitutes the closing element of the one way valve, thereby making the device able to be smaller, quieter, more comfortable and more efficient than any current technology.

### BRIEF DESCRIPTION OF DRAWINGS

FIG. 1 illustrates an isometric view of the original embodiment of the system closed prior to an inspiration.

FIG. 2 illustrates an isometric view of the original embodiment of the system open during an expiration cycle.

FIG. 3 illustrates an isometric view of the two filters joined by a safety strap which fits across the septum of the nose in the original embodiment.

FIG. 4 illustrates a side view of the two filters joined by a safety strap which fits across the septum of the nose.

FIG. 5 illustrates an isometric view of a pair of the filters from above in the preferred embodiment.

FIGS. 6a and 6b illustrate isometric views of the filter from below with a close up isometric view from below of a filter anchor post in the preferred embodiment.

FIG. 7 illustrates an isometric exploded view of the filter inserts in the preferred embodiment.

FIG. 8 illustrates a series of sectional views showing a series of increasing close ups of a sharp point retention system in a filter element in the preferred embodiment.

FIG. 9 illustrates a sectional view of a filter element in the preferred embodiment.

### EXPLANATION OF THE INVENTION

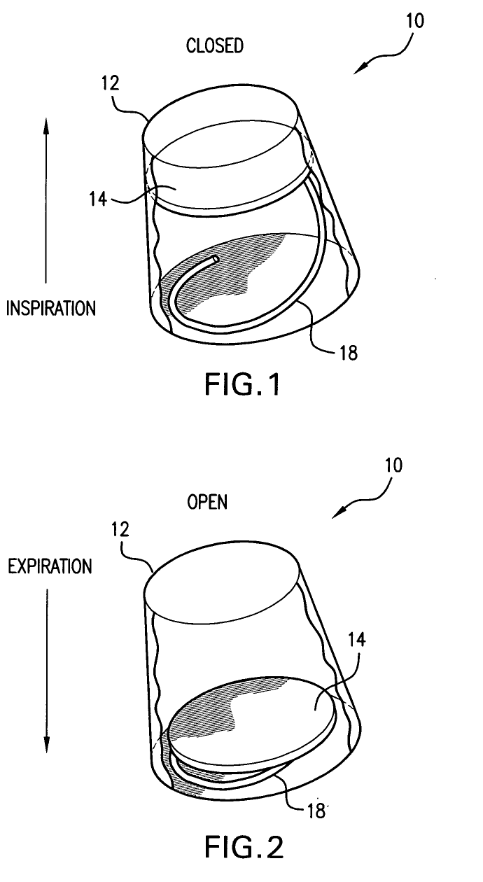

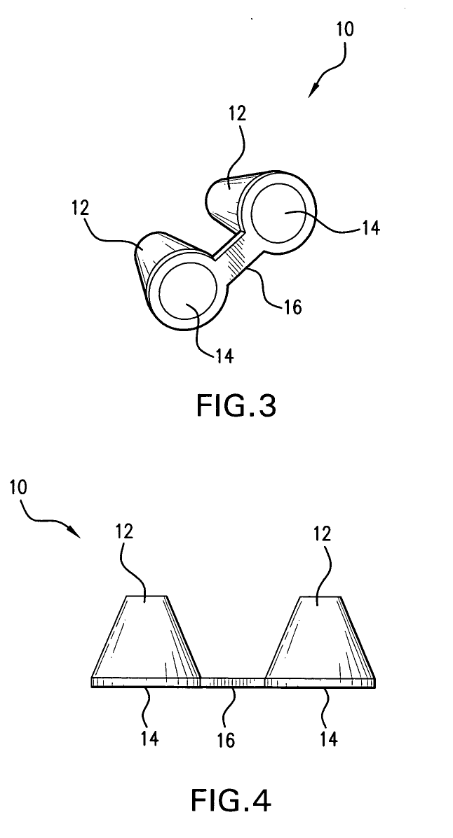

FIGS. 1 through 4 are the original embodiment for the invention which utilizes a pair of slightly conical nasal air filter units, one such filter being indicated generally at (10) comprised of a slightly conical tube (12) slightly wider at the bottom end than the top end which fits snugly in a nostril, comprised of a tissue friendly material or having a tissue friendly layer of hypoallergenic, soft rubber applied to the outside of the conical tube, a flat High Efficiency Particulate Arrestor (HEPA) disk shaped air filter (14) attached to a spring or spring means (18), the lower part of the spring means fixed to the lower portion of the cone inside the perimeter of the lower, wider end of the cone shaped tube (12), the spring means (18) fixed to the bottom of the High Efficiency Particulate Arrestor (HEPA) disk shaped air filter so that upon inhalation and exhalation the HEPA filter tends to act as a one way valve allowing filtered air to flow into the nostril on inspiration, but allowing unfiltered, unimpeded, exhaled air to flow out of the nostril on exhalation. When in use one filter is placed in each nostril, and the two of them are connected by a connecting strap (16).

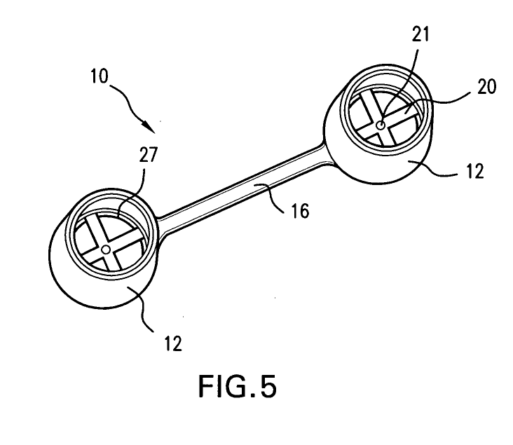

FIGS. 5 through 9 illustrate the preferred embodiment for the invention. For the spring means, instead of a spring holding the disk shaped filter element in place, an insert molded filter element is integrated into a baffle filter system comprised of two miniature “wagon wheels”. The first upper “wagon wheel” serves as an anchor for the lower filter element itself which is comprised of a filter element integrated into a second “wagon wheel”. This filter element is affixed to the upper wagon wheel by a center post. This allows the filter element to act as a baffle filter with increased permeability on exhalation, while engaging the filter on inhalation. In the preferred embodiment the filter element is insert molded to the second wagon wheel and this second wagon wheel is heat staked to the upper wheel. But any equivalent means of attaching or integrating the filter element to the lower wheel or affixing the lower wheel to the upper wheel could be used.

FIG. 5 shows an isometric view from above of a pair (10) of slightly conical nasal air filter units (12) connected by a connecting strap (16) looking from above without the lower filter ring in place. The upper miniature wagon wheel shaped anchor ring (27) having the upper spokes (20) is visible inside each slightly conical filter unit at the base of each unit. The center post hole (21) which is used to allow a post to be inserted to anchor the lower wagon wheel shaped filter ring is also visible. The preferred embodiment of the wagon wheel assemblies contains 4 spokes (20) each but any number of spokes may be used.

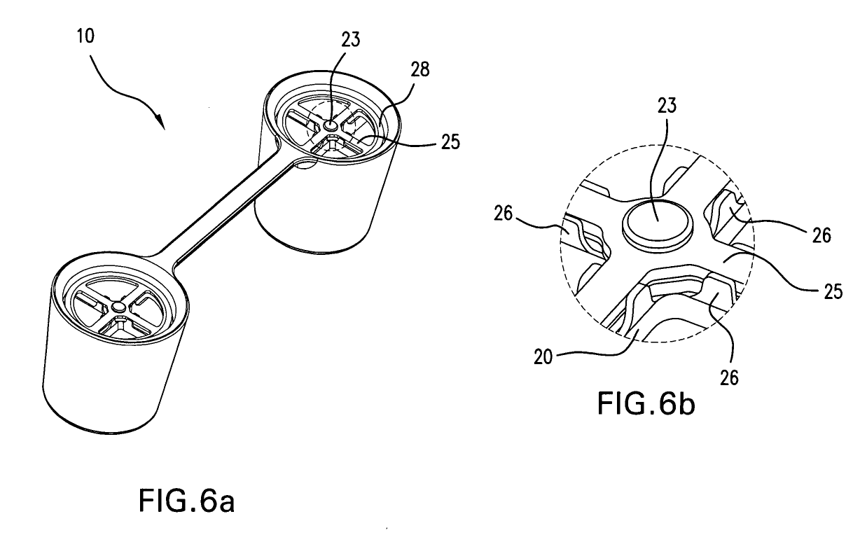

FIG. 6a shows an isometric view from below showing a pair of filter units (10) with the lower miniature wagon wheel shaped filter ring (28) in which the filter element is imbedded. The lower “spokes” (25) of the lower miniature wagon wheel shaped filter ring are also shown. This lower miniature wagon wheel shaped filter ring is anchored to the upper miniature wagon wheel shaped anchor ring by the center post (23).

FIG. 6b shows an enlarged isometric view of the center post assembly from FIG. 6a from below showing the gripper tabs (26) from each of the spokes (20) on the upper wagon wheel shaped anchor ring (27 in FIG. 5) which keep the spokes (25) of the lower miniature wagon wheel shaped filter ring (28) in place. The center post (23) is also shown.

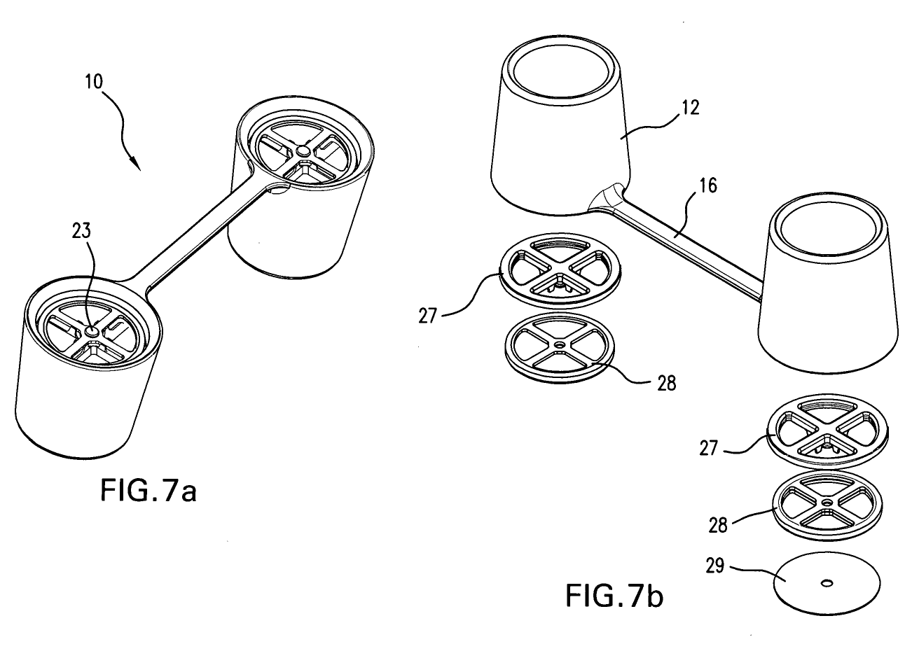

FIG. 7a shows an isometric view from below with the center post 23 highlighted.

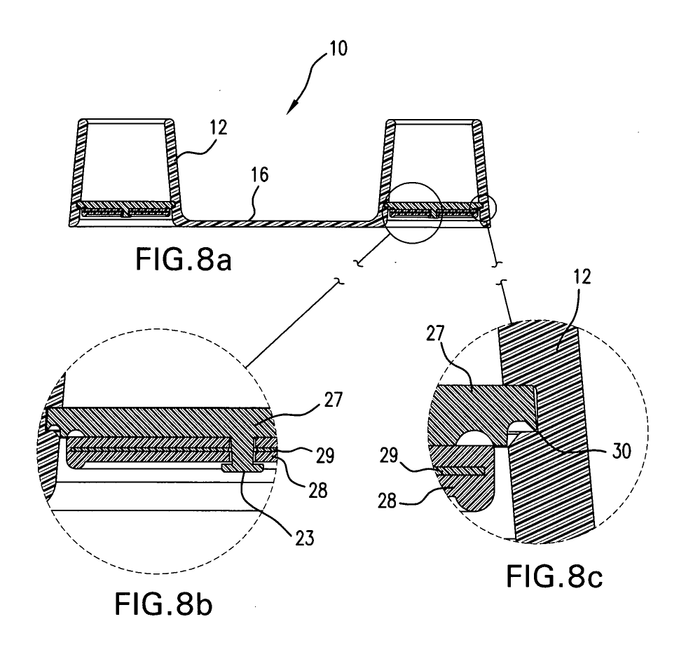

FIG. 7b shows an isometric exploded view of the baffle filter element construction for a pair of filter units, showing how the upper miniature wagon wheel shaped anchor ring (27) is seated on top of the lower miniature wagon wheel shaped filter ring (28). This lower wagon wheel shaped filter ring (28) has an air filter of the same diameter (29) fitted into its base so that it covers the entire horizontal aspect of the lower miniature wagon wheel shaped filter ring (28). The lower miniature wagon wheel filter ring can also have the circular filter element of the same diameter insert molded into it so that the filter element is an integral part of the lower miniature wagon wheel. (See FIG. 8 at 28 and 29)

FIG. 8a shows a sectional view of a pair of nasal filter units (10) with the slightly conical shaped tubes (12) and the connecting strap (16).

FIG. 8b shows an enlarged sectional view illustrating the upper miniature wagon wheel shaped anchor ring (27) anchoring the lower miniature wagon wheel shaped filter ring (28) with the center post (23), thereby securing the filter element (29) which is embedded into the lower miniature wagon wheel filter ring (28).

FIG. 8c shows a further enlarged cross section of the outer perimeter of the upper miniature wagon wheel shaped anchor ring (27) anchored to the interior wall of the slightly conical tube (12). In the preferred embodiment a sharp point (30) built into the lower peripheral edge of the upper wagon wheel shaped anchor ring (27) is inserted into a groove in the interior side wall of the lower part of the slightly conical tube (12) to anchor it and to prevent rotation and slipping. This sharp point (30) is embedded during manufacture into the side wall of the conical tube (12) to anchor the upper wagon wheel shaped anchor ring (27) to the sidewall of the conical tube (12) so that the upper miniature wagon wheel shaped securing anchor ring (27) can be anchored by a post to the lower miniature wagon wheel shaped securing filter ring (28) with the filter element material (29) integrated within it.

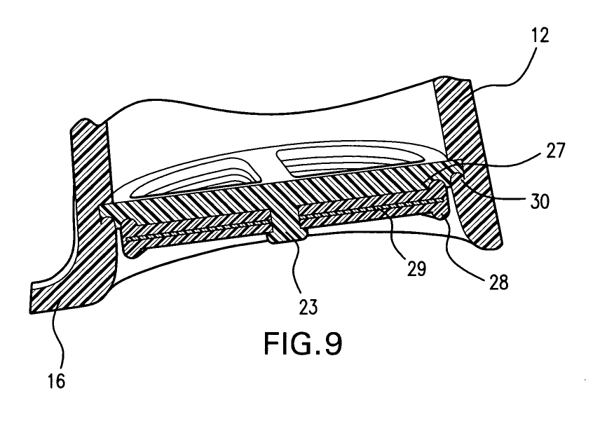

FIG. 9 shows an orthogonal sectional view of the filter unit showing a portion of the connecting strap (16), a side wall of a slightly conical tube (12), an upper miniature wagon wheel shaped anchor ring (27) with a sharp point (30) embedded in the side wall of the conical tube (12) anchoring a lower miniature wagon wheel shaped filter ring (28) which has a filter element (29) insert molded into it, the entire lower miniature wagon wheel shaped anchor ring (28) with the filter (29) embedded into it being anchored by a center post (23).

I claim:

1. A nasal air purifier comprising:
(a) a slightly conical tube wider at the bottom end than the top end which fits snugly in a nostril;
(b) a tissue friendly layer of hypoallergenic, soft rubber applied to the outside of the conical tube;
(c) a flat disk shaped air filter attached to a spring;
(d) the lower part of the spring fixed to the inside perimeter of the lower, wider end of the conical tube;
(e) the spring affixed to the bottom of the flat disk air filter so that upon inhalation and exhalation the flat disk air filter acts as a one way valve allowing filtered air to flow into the nostril, but unimpeded exhaled air to flow out of the nostril;
(f) a strap attached to the base of the slightly conical tube for attachment to a second identical conical tube for insertion into the other nostril;
(g) a second identically constructed slightly conical tube attached to the other end of the strap.
(h) each one of the conical tubes inserted in one nostril with the narrower side up so that upon inhalation and exhalation through the nostrils the flat disk air filter elements act as one way valves allowing filtered air to flow into the nostrils, but allowing exhaled air to be unimpeded as it flows out of the nostrils.

2. A nasal air purifier comprising the apparatus in claim 1 wherein the slightly conical circular tube is comprised of a tissue friendly material.

3. The apparatus in claims 1 and 2 wherein the filter element material used is a High Efficiency Particulate Arrestor (HEPA) Filter.

4. A nasal air purifier comprising:
(a) a slightly conical tube comprised of a tissue compatible material wider at the lower end than the top end which fits snugly inside a nostril;
(b) an upper miniature wagon wheel shaped anchor ring that will fit within the wider end of the conical tube;
(c) the slightly conical tube having a groove in the interior side wall of the lower part of the tube extending around the entire interior side wall;
(d) the upper miniature wagon wheel shaped anchor ring inserted into the groove in the interior side wall of the lower part of the slightly conical tube;
(e) a lower miniature wagon wheel shaped filter ring of the same diameter as the upper miniature wagon wheel shaped anchor ring;
(f) a disk shaped air filter of the same diameter as the lower miniature wagon wheel shaped filter ring;
(g) the disk shaped filter attached by an attachment means onto the base of the lower miniature wagon wheel shaped filter ring so as to cover the entire horizontal surface of the lower miniature wagon wheel shaped filter ring;
(h) the lower miniature wagon wheel shaped filter ring being anchored in its center to the upper miniature wagon wheel shaped anchor ring by an anchor means;
(i) a flexible strap connecting the conical tube at one point of the wider end with an identically constructed conical tube at the other end of the strap so that one conical tube can be inserted in each nostril;
(j) a second identically constructed slightly conical tube attached to the other end of the strap.
(k) each one of the conical tubes inserted in one nostril with the narrower side up so that upon inhalation and exhalation through the nostril the lower miniature wagon wheel shaped ring with a filter imbedded into it acts as a one way valve allowing filtered air to flow into the nostril, but allows air to be unimpeded as it flows out of the nostril.

5. The apparatus in claim 4 wherein the filter element material used is a High Efficiency Particulate Arrestor (HEPA) Filter.

6. The apparatus in claim 4 wherein the disk shaped filter is embedded by an embedding means into the lower miniature wagon wheel shaped filter ring so that it becomes an integral part of the lower miniature wagon wheel shaped filter ring.

7. The apparatus in claim 4 wherein:
(a) the perimeter of the base of the upper miniature wagon wheel shaped anchor ring ends in a sharp point around it's entire outer circumference;
(b) the sharp point around the entire outer circumference of the lower perimeter of the base of the anchor ring is embedded into the groove in the interior side wall of the lower part of the tube.

8. The apparatus in claim 4 wherein the lower miniature wagon wheel shaped filter ring is anchored in its center to the upper miniature wagon wheel shaped anchor ring by a post.

9. A method of manufacturing the apparatus in claim number 4 wherein the filter element is insert molded into the lower miniature wagon wheel shaped filter ring to produce an integrated wagon wheel shaped filter element structure with the filter element embedded into the lower miniature wagon wheel.

10. The method of manufacture in claim 9 wherein the lower miniature wagon wheel shaped filter ring is heat staked by a post to lock it to the upper miniature wagon wheel shaped securing anchor ring.
